(19) United States
(12) Patent Application Publication
(10) Pub. No.: US 2006/0017941 A1
(43) Pub. Date: Jan. 26, 2006

(54) Information processing system

(75) Inventors: Yukinobu Momozono, Nagano (JP); Yuji Matsueda, Nagano (JP); Satoshi Iinuma, Nagano (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 11/038,776

(22) Filed: Jan. 19, 2005

(30) Foreign Application Priority Data
Jan. 20, 2004 (JP) P2004-011858

(51) Int. Cl. G06F 15/00

(52) U.S. Cl. 358/1.1

(57) ABSTRACT

The information processing system including an information processor and an auxiliary information processor (scan agent computer) so that, for some of the processing condition item setting screens displayed by the information processor, selectable item information is acquired from the auxiliary information processor to provide a screen displaying the contents specified by the selectable item information.

### BACKGROUND OF THE INVENTION

The present invention relates to an information processing system where an information processor and an auxiliary information processor perform information processing in cooperation.

Some of the digital multifunction devices recently available on the market are ready for “scan-to-mail processing” or “scan-to-file processing” when they are connected to a LAN and a predetermined program (hereinafter referred to as a feature addition program) has been installed in a computer on the LAN.

As schematically shown in FIG. 26A, the “scan-to-mail processing” refers to processing where scan data (image data of a document generated by way of a scanner of a digital multifunction device) is transmitted from the digital multifunction device to a computer and an e-mail to which a file of data obtained by processing the scan data (data in converted form) is attached is transmitted to several destinations specified by the user by way of the computer which has received the scan data. As schematically shown in FIG. 26B, the “scan-to-file processing” refers to processing where scan data is transmitted from the digital multifunction device to a computer and a file of data obtained by processing the scan data is transmitted to a destination specified by the user (shared folder) by way of the computer which has received the scan data.

The digital multifunction device is, same as a general digital multifunction device, displays various screens of predetermined contents in order for the user to set processing conditions for scan-to-mail processing and scan-to-file processing as well as notifies a computer of part of the processing conditions set by the user (processing conditions concerning file format and destination), generate and transmit to the computer the scan data corresponding to the remainder of the processing conditions (processing conditions concerning the operating conditions for the scanner, when start of file processing is instructed.

Thus, a system comprising the digital multifunction device and a computer (feature addition program) must perform for example update of firmware of the digital multifunction device for selection of added/changed file formats by the user in case an available file format is added or types of selectable file formats are changed as well as update of a feature addition program for conversion of scan data to an added/changed file format.

The digital multifunction device has a problem that it cannot change the name of a certain choice displayed on the screen without update of firmware.

### SUMMARY OF THE INVENTION

An object of the invention is to provide an information processing system where an information processor and an auxiliary information processor perform information processing in cooperation with each other, the information processing system capable of performing feature addition without performing work on the information processor.

In order to solve the aforesaid object, the invention is characterized by having the following arrangement.
(1) An information processing system comprising one or more information processors and auxiliary information processors which cooperates to execute information processing, wherein each of the one or more information processors comprises:

a user-interface unit that displays plural types of screens to allow a user to specify an item value of each of plural types of processing condition items concerning the information processing and displays a screen that represents contents specified by screen contents specification information acquired from the auxiliary information processor for some of the screens;

a user setting item value information transmitter that transmits, to the auxiliary information processor, user setting item value information including the item value of each of the plural types of processing condition items set by the user through the user-interface unit; and

a processing execution unit that executes processing of contents specified by process contents specification information transmitted by the auxiliary information processor and transmits processing result information to the auxiliary information processor;

wherein the auxiliary information processor comprises:

a process contents specification information transmitter that generates, on receiving the user setting item value information, the process contents specification information corresponding to the user setting item value information and transmits the user setting item value information to the information processor;

an information processing completion unit that completes, on receiving the processing result information, the information processing by performing secondary processing corresponding to the user setting item value information received from the process contents specification information transmitter concerning the processing result information; and

a screen contents specification information storage that stores the screen contents specification information on each of the some of the screens to be acquired by the user-interface means of the information processor.
(2) The information processing system according to (1), wherein the screen contents specification information stored into the screen contents specification information storage of the auxiliary information processor include information including a plurality of item values and an item value name associated with each item value, and

wherein the user-interface unit displays a screen where the item value name included in the screen contents specification information is shown.
(3) The information processing system according to (1), wherein the auxiliary information processor is a computer storing an auxiliary information processing program for operating a computer as the process contents specification information transmitter, the information processing completion unit, and a screen contents specification information provision unit that provides the user with screen contents specification information.
(4) The information processing system according to (1), wherein the processing execution unit generates image data representing an image on a document to be processed and transmits as the processing result information the generated image data to the auxiliary administration device.
(5) The information processing system according to (4), wherein the user-interface unit allows the user to set an item value group including a storage location specification value which is an item value concerning a folder path, and wherein the information processing completion unit performs, as the secondary processing, processing of storing a file of the image data transmitted as the processing result information into a folder specified by the storage location specification value included in the user setting item value information.
(6) The information processing system according to (4), wherein the user-interface unit allows the user to set an item value group including a mail transmission specification value which is an item value concerning a mail address, and

wherein the information processing completion unit performs, as the secondary processing, the processing of transmitting an e-mail, to which the file of the image data transmitted as the processing result information is attached, to the mail address specified by the mail destination specification value included in the user setting item value information.

That is, the information processing system according to the invention can change the number/types of item values selectable by using a screen for setting several processing condition items displayed by the information processor, by using the screen contents specification information in the auxiliary information processor. As a result, the information processing system according to the invention can add features without performing work on the information processor.

When implementing the information processing system according to the invention, the “item value” maybe information presented to the user. The information (item value name) presented to the user together with the “item value” may be passed from an auxiliary processor to an information processor.

The information processing system according to the invention may be implemented as a system for executing any information processing. The information processing system may be, for example, a system for executing information processing in which image data representing an image on an document to be processed is generated and some processing is made based on the image data, such as storing the image data into a file or transmitting an e-mail to which the image data file is attached.

### BRIEF DESCRIPTION OF THE DRAWINGS

FIG. 1 illustrates the configuration and usage pattern of an information processing system according to an embodiment of the invention;

FIG. 2 is an external view of a digital multifunction device;

FIG. 3 is a block diagram of the digital multifunction device;

FIG. 4 is an external view of a control unit included in the digital multifunction device;

FIG. 5 illustrates a copy basic screen displayed by the control unit;

FIG. 6 illustrates a user name selection screen displayed by the control unit;

FIG. 7 illustrates a scan basic screen displayed by the control unit;

FIG. 8 illustrates a scan destination selection screen displayed by the control unit;

FIG. 9 illustrates a file format setting screen displayed by the control unit;

FIG. 10 illustrates a document size setting screen displayed by the control unit;

FIG. 11 illustrates a file format setting screen displayed by the control unit;

FIG. 12 illustrates a document type setting screen displayed by the control unit;

FIG. 13 illustrates the information stored into a scan agent computer included in the information processing system;

FIG. 14 is a flowchart of IP address registration/check processing executed by the scan agent computer;

FIG. 15 illustrates a scan user setting page provided by the scan agent computer;

FIG. 16 illustrates a folder setting page provided by the scan agent computer;

FIG. 17 illustrates a destination setting page provided by the scan agent computer;

FIG. 18 illustrates a destination group setting page provided by the scan agent computer;

FIG. 19 is a sequence chart showing the operation procedure of the information processing system;

FIG. 20 is another sequence chart showing the operation procedure of the information processing system;

FIG. 21 is another sequence chart showing the operation procedure of the information processing system;

FIG. 22 illustrates selectable item information to display a file format setting screen shown in FIG. 23;

FIG. 23 illustrates a file format setting screen displayed in the selectable item information shown in FIG. 22;

FIG. 24 illustrates a file format setting screen displayed in the selectable item information shown in FIG. 25;

FIG. 25 illustrates selectable item information to display a file format setting screen shown in FIG. 24; and

FIG. 26 illustrates scan-to-mail processing and scan-to-file processing performed by an existing system.

### DETAILED DESCRIPTION OF PREFERRED EMBODIMENTS

The best embodiment to implement the invention is detailed below referring to the drawings.

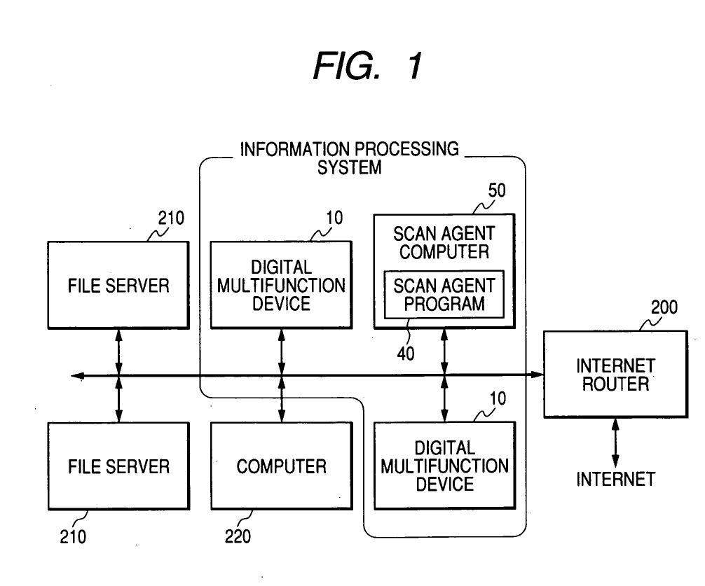

The outline, or hardware configuration and usage pattern of an information processing system according to an embodiment of the invention is described below referring to FIGS. 1 through 4.

As shown in FIG. 1, the information processing system according to this embodiment is a system where one or more (two in FIG. 1) digital multifunction devices 10 (corresponding to an information processor) and a scan agent computer 50 (corresponding to an auxiliary information processor) are connected via a network.

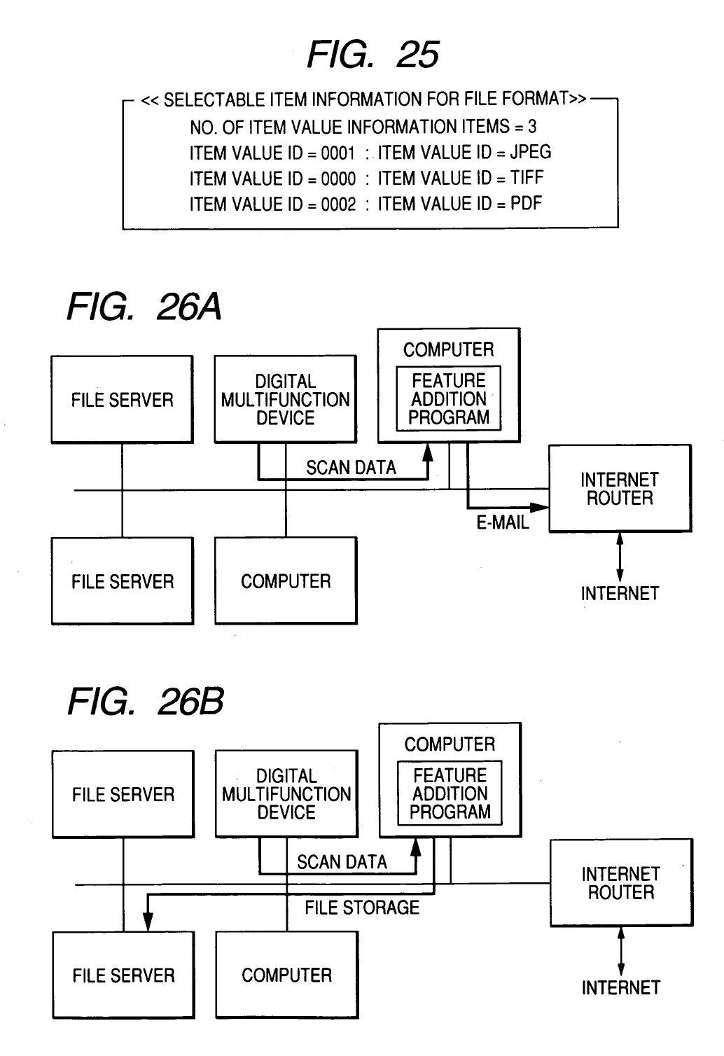

The information processing system is a system for executing scan data processing in which either scan-to-mail processing or scan-to-file processing (refer to FIG. 25A, FIG. 25B) of both of them are performed. Thus, the information processing system is used while connected to a network including several (one in FIG. 1) computers 220 used by an administrator of this information processing system or a general user, an internet router 200 for connecting the computer 220 to the Internet, and several file servers 210 in which a shared folder is set.

The scan agent computer 50 is a computer in which is installed a scan agent program 40 (corresponding to an auxiliary information processing program) developed for this scan data transmission system. While the feature of the scan agent program 40 will be described later, the scan agent program 40 requires setting of an administrator's name, a password, a work folder and a mail server in installation (setup).

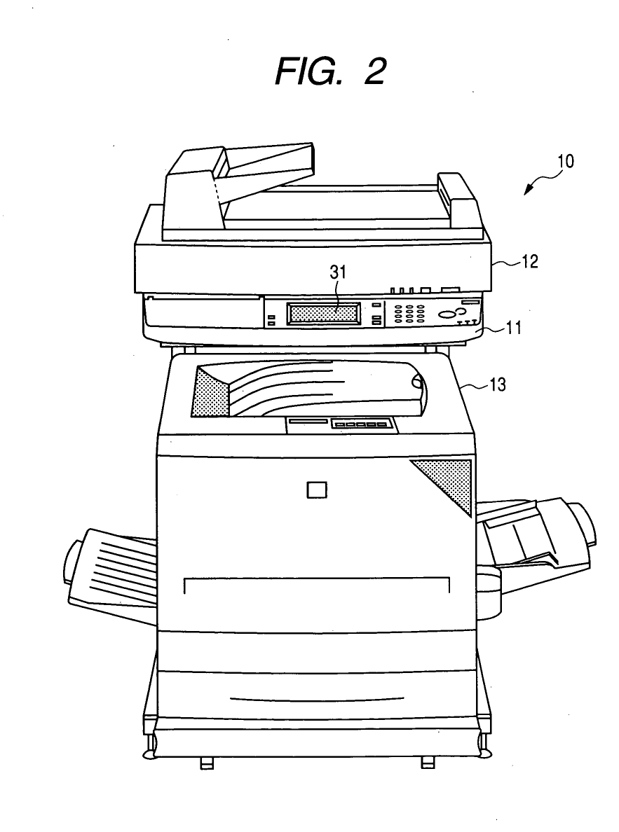

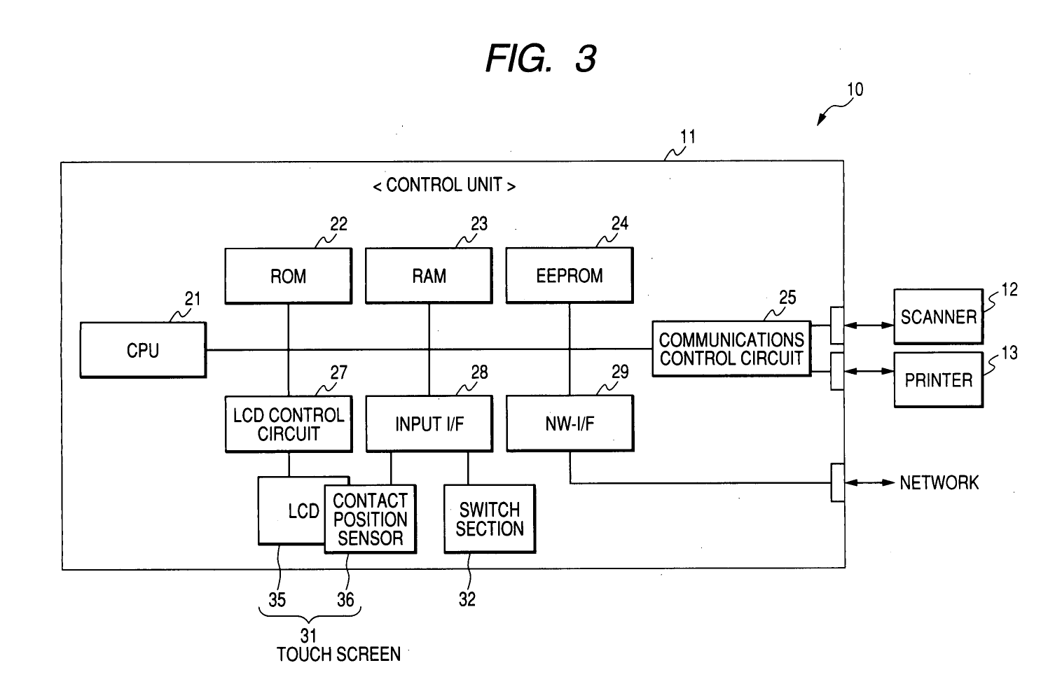

The digital multifunction device 10 is a device having an external appearance and hardware configuration respectively shown in FIGS. 2 and 3. The digital multifunction device 10 is a combination of a control unit 11, a scanner 12 and a printer 13 so as to provide the same external appearance as a general digital multifunction device/copier.

A printer 13 used for the digital multifunction device 10 is a printer available as a peripheral device of a computer with an extension board attached for implementing the digital multifunction device 10, that is, for connecting the control unit 11 and the printer 13. The scanner 12 is a scanner available as a peripheral device of a computer with an extension board attached for implementing the digital multifunction device 10, that is, for connecting the control unit 11 and the scanner 12.

The control unit 11 comprises, as shown in FIG. 3, a CPU 21, a ROM 22, a RAM 23, an EEPROM 24, a communications control circuit 25, an LCD control circuit 27, an input interface circuit (input I/F) 28, a network interface circuit (NW-I/F) 29, a touch screen 31, and a switch section 32.

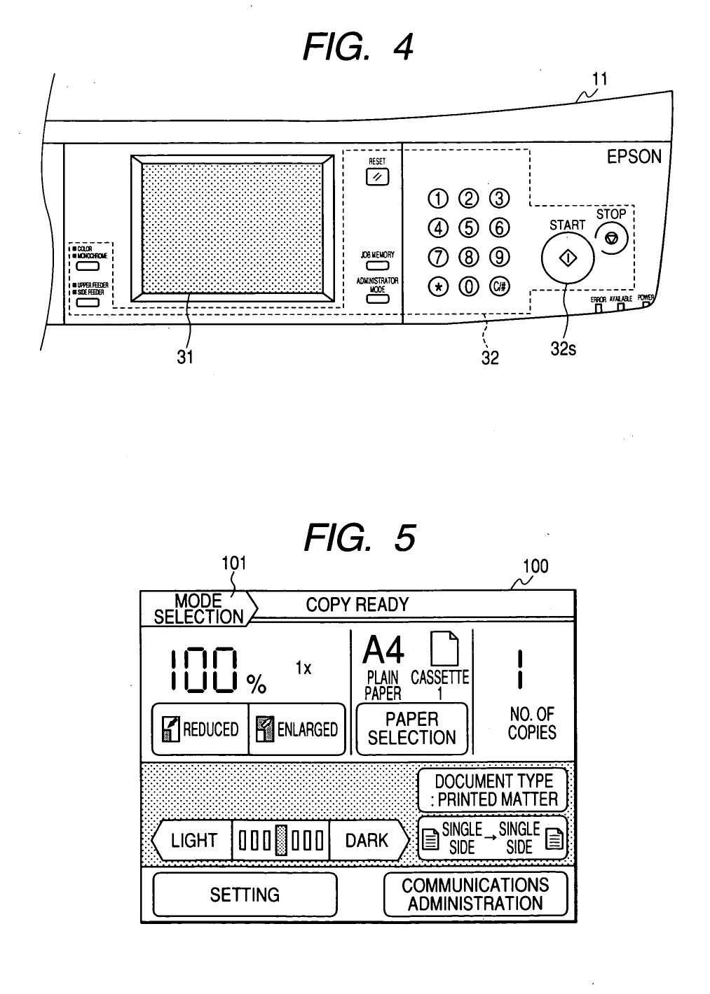

The touch screen 31 of the control unit 11 is a device comprising a liquid crystal display (LCD) 35 on which a transparent contact position sensor 36 is provided. The switch section 32 (refer to FIGS. 3 and 4) is a unit comprising various pushbutton switches such as a start button 32s and a ken-key pad provided on the enclosure of the control unit 11 and a control circuit for these switches.

The CPU 21 (FIG. 3) is a control circuit for integrally controlling each section of the digital multifunction device 10 (each section of the control unit 11, the scanner 12 and the printer 13). The ROM 22 is a read-only memory in which is recorded data used by a program which specifies the operation procedure of the CPU 21 and the CPU 21 (various programs). The RAM 23 is a memory from which a program recorded in the ROM 22 is read and also a memory used as a work area for the CPU 21 (or various programs). The communications control circuit 25 is a circuit used by the CPU 21 to communicate information to/from the scanner 12 or the printer 13, for example transmitting commands, receiving image data, and transmitting print data.

The LCD control circuit 27 is a circuit which causes the touch screen 31 (LCD 35) to display an image (screen) instructed by the CPU 21. The input interface circuit 28 is a circuit for communicating the operation of the user (operator of the digital multifunction device 10) on the ten-key pad 32 or the touch screen 31 (contact position sensor 36) to the CPU 21. The network interface circuit 29 is a circuit for connecting the control unit 11 to a LAN.

The EEPROM 24 is a nonvolatile rewritable memory mounted on the control unit 11 so as to store various information such as a device IP address and an agent IP address which must be retained even when the power is turned off.

Operation of the scan data transmission system is described below referring to FIGS. 5 through 12.

The control unit 11 has, as its operation modes, a copy mode for operating the digital multifunction device 10 as a copier and a scan mode for operating an information processing system comprising the digital multifunction device 10 and the scan agent computer 50 as an actually operating system. When operating in the copy mode, the control unit 11 serves as unit which typically displays a copy basic screen 100 shown in FIG. 5 on the touch screen 31.

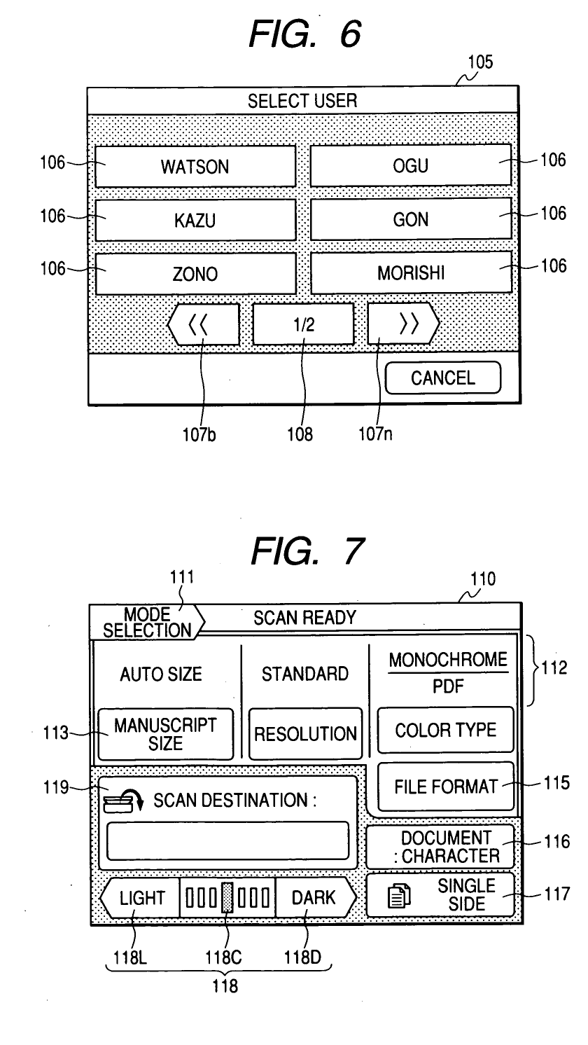

When wishing to cause the control unit 11 to start scan mode operation (when wishing to cause the information processing system to execute scan data transmission processing), the user presses a mode selection button 101 on the copy basic screen 100. When this operation is made, the control unit 11 starts scan mode operation. As a result, a user name selection screen 105 shown in FIG. 6 is displayed on the touch screen 31.

The user presses a user name button 106 on which is shown his/her name (the name registered to the information processing system such as “WATSON”) on the user name selection screen 105. In case the user name button 106 concerning the user is absent on the user name selection screen 105 displayed, the user presses a button 107n. When the user presses the button 107n on the user name selection screen 105, the touch screen 31 displays a user name selection screen 105 (user name selection screen 105 on which the contents on the next page are displayed) comprising six or less user name buttons 106 concerning other registered users, an effective button 107b, an ineffective button 107n (gray-out displayed and insensitive to a push) and an area 108 in which “2/2” is displayed. The user presses the user name button 106 on which his/her name is displayed on the user name selection screen 105.

When the user presses the user name button 106 on which his/her name is displayed, in case the user has not set a password (in case the pressed user name button is related to a user who has not set a password; detailed later), the scan basic screen 110 shown in FIG. 7 is displayed on the touch screen 31. In case the user has set a password, a password input screen is displayed on the touch screen 31. When a password (four-digit numeral) matching a registered one is input to the password input screen, a scan basic screen 110 is displayed.

A mode selection button 111 on the scan basic screen 110 is a button which triggers, when pressed, copy mode operation by the control unit 11.

A scan destination selection button 119 is a button which displays, when pressed, a scan destination selection screen 120 on the touch screen 31.

A list area 121 of the scan destination selection screen 120 is an area where the name of each destination specification information item pre-registered by the user (such as “FOLDER_{—}1”, “USER_{—}1”: hereinafter also represented as a destination specification information item name) is shown. While the details (contents and setting method) of destination specification information will be given later, the destination specification information is information which specifies a scan file storage location and a scan mail destination. This information processing system can register, as destination specification information, the destination specification information for scan-to-file processing (including a folder path; hereinafter referred to as the destination specification information for storage), destination specification information including one mail address for scan-to-mail processing (hereinafter referred to as the destination specification information for mail), and destination specification information including a plurality of mail addresses for scan-to-mail processing (hereinafter referred to as the destination specification information for group). In the list area 121 on the scan destination selection screen 120, a graphics 128 and its name (“FOLDER_{—}1”) are shown for each destination specification information item for storage, its name (such as “USER_{—}1”) alone for each destination specification information item for mail, and a graphics 129 and its name (“GROUP_{—}1”) for each destination specification information item for group.

The scan destination selection screen 120 allows selection of an arbitrary number of scan data destinations (storage location of a file generated from scan data and destination of an e-mail to which a file generated from scan data is attached), by way of the operation described below.

The user wishing to select a certain destination specification, operates a button 122u and a button 122d to form a state where destination specification information item name is enclosed by a selection frame 126. Then the user presses an “Add to scan destination” button 123.

When the user presses the “Add to scan destination” button 123, the control unit 11 stores selection of destination specification information identified by the destination specification information item name enclosed by the selection frame 126 (detailed later). The control unit 11 increments the numeric value in a selection count display column 124 by “1” as well as erases the destination specification information item name enclosed by the selection frame 126 from the list area 121.

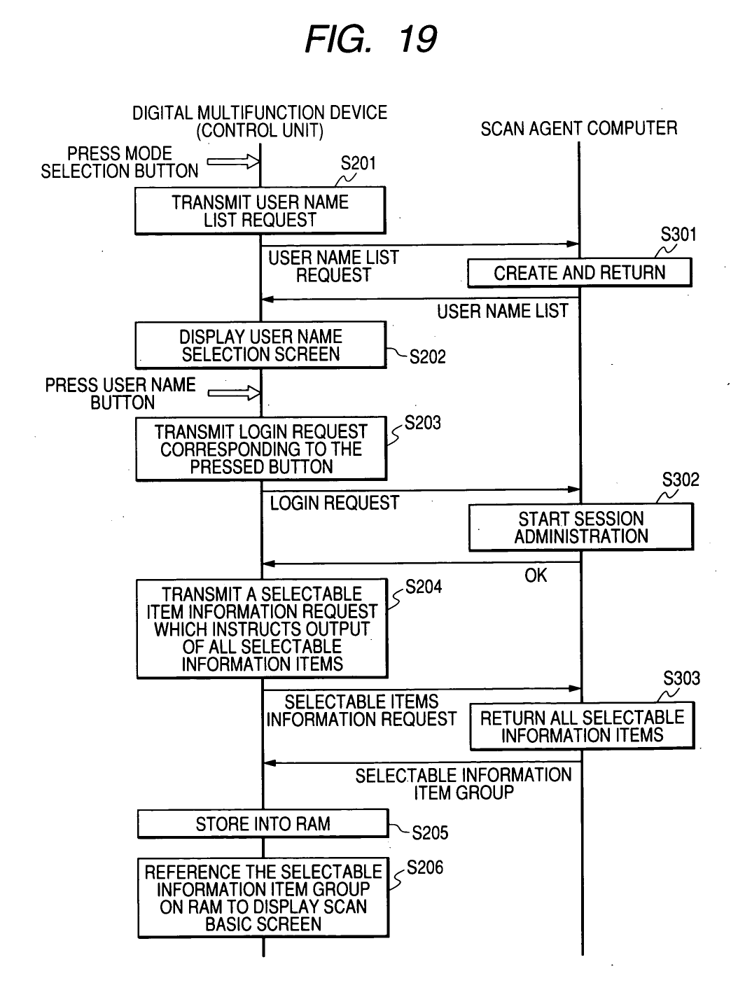

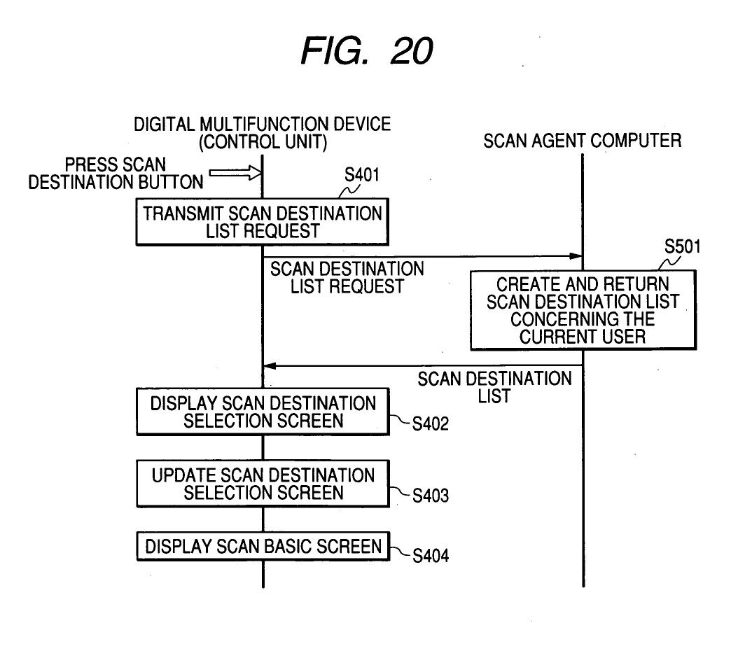

In case a plurality of destination specification information items are selected, the user performs the above operation for each destination specification information item and presses an “OK” button 125. A scan destination button 127 on the scan destination selection screen 120, when pressed, causes the scan destination check/deletion screen 130 shown in FIG. 19 to be displayed on the touch screen 31. The user wishing to check the selected destination specification information presses a “Scan destination” button 126 to display the scan destination check/deletion screen. After checking the contents, the user presses the “OK” button 135 on the scan destination check/deletion screen 130 (or “OK” button 125 on the scan destination selection screen 120 re-displayed by pressing a “List” button).

When the user presses the “OK” button 125 (or an “OK” button 135), the scan basic screen 110 is displayed on the touch screen 31 where the information concerning the destination specification information selected by the user (a list of destination specification information item names) is displayed in the scan destination selection/display button 119.

Description will be continued referring to FIG. 7 again.

A set value presentation area 112 provided n the scan basic screen 110 shows four types of set values (such as “Auto size” and “Standard”) concerning four types of processing condition items (document size, resolution, color type, and file format). A set value concerning a certain processing condition items is an item value to be used as information which specifies the contents of scan data transmission processing in case the Start button 32s is pressed unmodified among a plurality of items values provided for the processing condition item. The item value refers to information including information to be presented to the user (such as an item value name) and information to be used in real processing (such as an item value ID).

A “Document size” button 113, a “Resolution” button, a “Color type ” button, and a “File format” button 115 respectively change a set value concerning the document size, resolution, color type and file format when pressed by the user.

A “Document type” button 116 is pressed by the user to specify the document type (processing condition item concerning whether the document is printed matter, a photograph, or a document most of which includes characters). The “Document type” button 116 shows therein a set value (characters in the figure) at that point in time. A single/double side selection button 117 is used to specify whether both sides or single side of a document is to be read. The single/double side selection button 117 also shows therein a set value (single side in the figure) at that point in time.

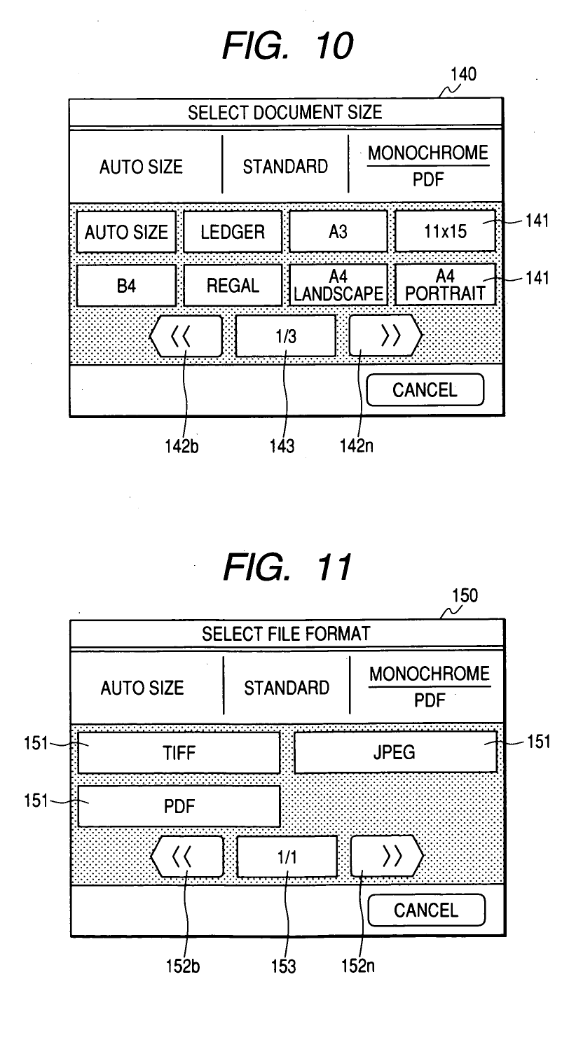

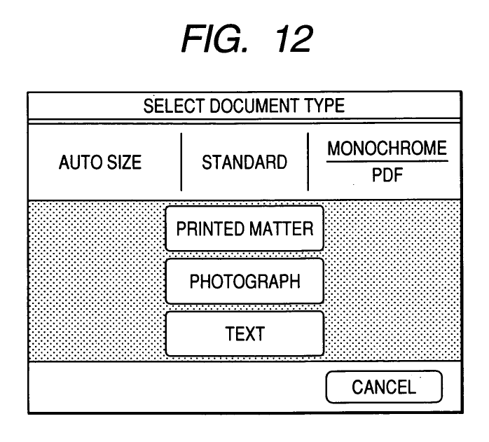

Pressing one of the buttons displays another screen for changing the set value of a corresponding processing condition item on the touch screen 31. For example, the “Document size” button 113, when pressed, displays a document size setting screen 140 shown in FIG. 10 on the touch screen 31. The “File format” button 115, when pressed, displays a file format setting screen 150 shown in FIG. 11. The “Document type” button 116, when pressed, displays a document type setting screen shown in FIG. 12. In the following description, a screen such as the document size setting screen 140 and the file format setting screen 150 (a screen other than the scan destination selection screen 120 displayed by operating the scan basic screen 110) is referred to as an item value selection screen.

A density setting item 118 (such as a “Light” button 118L and a “Dark” button 118D, and a set value presentation cursor 118C) on the scan basic screen 110 (FIG. 7) is an item used to change a set value concerning scan density. For the density setting item 118, pressing the “Light” button 118L or “Dark” button 118D does not display another screen (pressing the button shifts the display position of the set value presentation cursor 118C).

This information processing system starts scan data transmission processing corresponding to various set values at that point in time when the user has pressed a Start button 32s (FIG. 4) after making various setting operations on the scan basic screen 110.

Operation of the information processing system will be detailed based on the foregoing discussion.

The information processing system is a system in which the information specifying the contents of the above screens is stored in the scan agent computer 50.

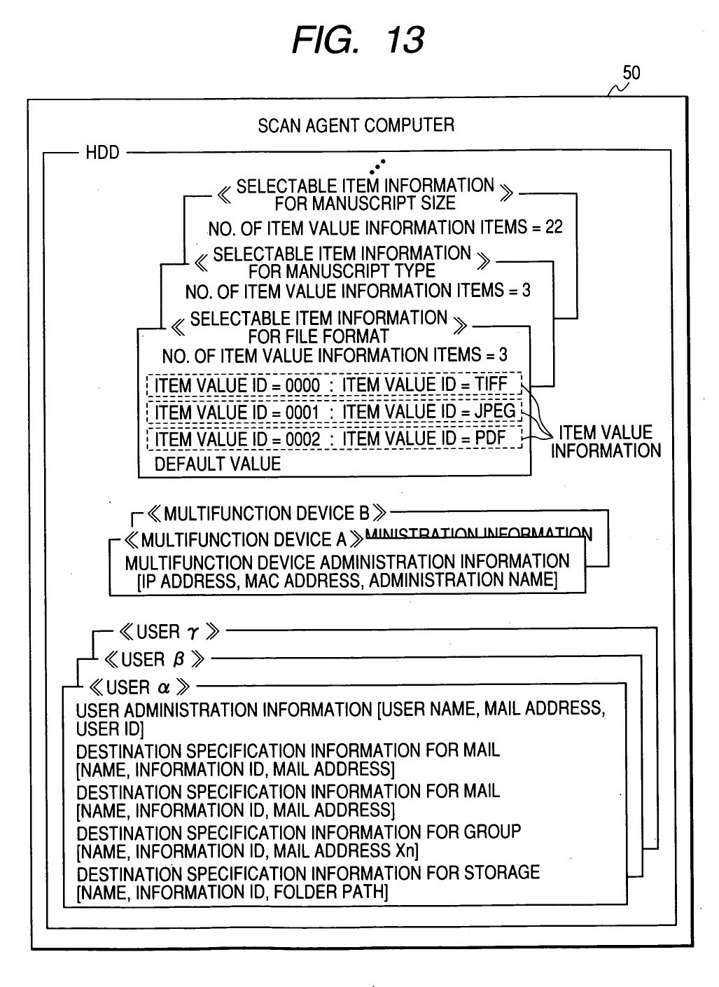

To be more precise, as schematically shown in FIG. 13, is a system which operates while a plurality of selectable information items (corresponding to the screen contents specification information of the invention), multifunction device administration information concerning each digital multifunction device 10 (Multifunction Device A, B in the figure), user administration information and several destination specification information items (destination specification information items for mail/group/storage) concerning each user (user α, β, γ in the figure) are stored in the scan agent computer 50.

Each selectable information item is information stored into the HDD of the scan agent computer 50 when the scan agent program 40 is installed (set up).

Each selectable information item is associated with any processing condition item which can be set by way of operation on the scan basic screen 110. In general, each selectable information item includes the information which specifies the contents of a screen (such as the file format setting screen 150) used to change the set value of a corresponding processing condition item, that is, a plurality of item value information topics including item value IDs and item value names as well as the number of item value information topics indicating the total count of item value information topics, and the default value (item value ID) which specifies the default set value of the processing condition item. Note that the selectable item information concerning scan density includes the information which specifies a selectable range of scan density (information which specifies how many scan density levels can be selected for the density setting item 118) and the default value. The information processing system is a system where an individual selectable information item is stored in a file (actually an INI file).

Multifunction device administration information stored in each digital multi function device 10 includes the IP address, MAC address and administration name of the corresponding digital multifunction device 10. Storage of each multifunction device administration information item into an HDD (registration to the scan agent computer 50) is automatically performed when initial setting of the digital multifunction device 10 is carried out.

To be more precise, the control unit 11 is a unit which requires assignment of an IP address (hereinafter referred to as a device IP address) and storage of an IP address assigned to the scan agent computer 50 (hereinafter referred to as an agent IP address) in its installation (integration into a network).

The control unit 11 is designed so that such procedures will be made by operating the ten-key pad and the touch screen 31 on the control unit 11 and the device IP address and the agent IP address set through the procedures will be stored on the EEPROM 24.

The control unit 11 is designed to transmit, in case a device IP address and an agent IP address are stored in the EEPROM 24 or the device IP address and the agent IP address have been changed at power on, an IP address registration/acknowledgment request comprising information indicating the device IP address, the MAC address of the unit (network interface circuit 29), the model name of the unit, the model name of the scanner 12 and attachment of an optional device (ADF) of the scanner 12, to a device identified by the agent IP address stored in the EEPROM 24.

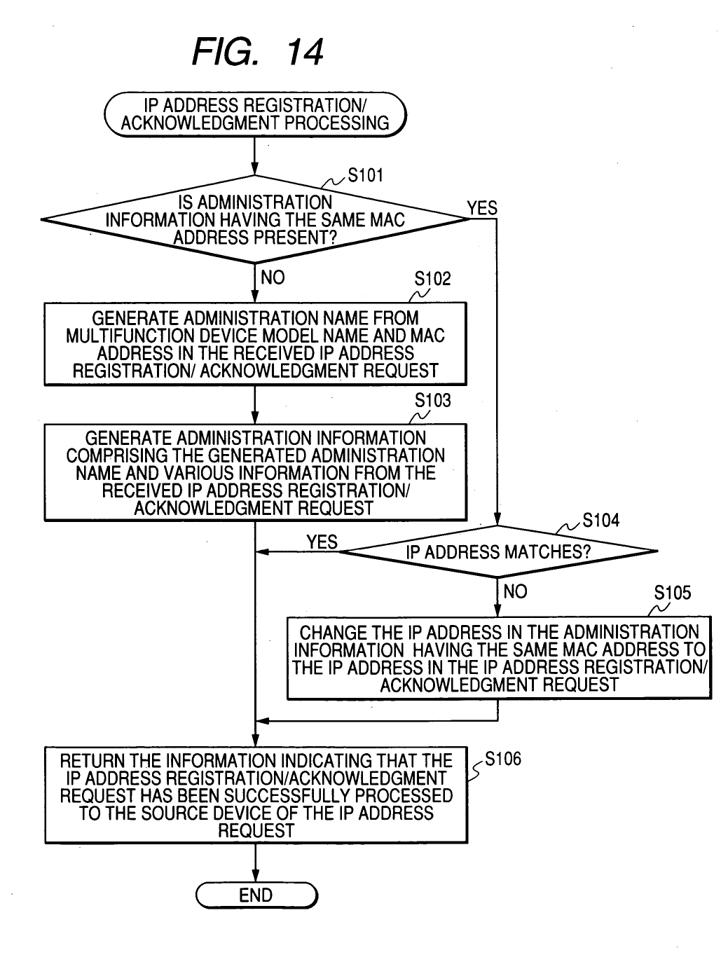

The scan agent program 40 is a program which causes the scan agent computer 50 to execute the IP address registration/acknowledgment processing in the procedure shown in FIG. 14, on reception of the IP address registration/acknowledgment request.

The scan agent computer 50, receiving the IP address registration/acknowledgment request, determines whether the multifunction device administration information corresponding to the IP address registration/acknowledgment request is stored in the computer (in a predetermined folder in the HDD of the computer) (S101). The multifunction device administration information corresponding to the received IP address registration/acknowledgment request comprises the same MAC address as that included in the received IP address registration/acknowledgment request (refer to FIG. 5).

In case the multifunction device administration information corresponding to the received IP address registration/acknowledgment request is not stored in the computer (S101; NO), the scan agent computer 50 generates an administration name by combining the model name of the control unit 11 and part of the MAC address included in the IP address registration/acknowledgment request (S102). Then the scan agent computer 50 generates the multifunction device information including the generated administration name and each information item included in the received IP address registration/acknowledgment request and stores the resulting information into the computer (S103). The actual processing in S102 is processing to generate a character string comprising the model name of the control unit 11 followed by the last four letters of the MAC address. The actual processing in S103 is processing to generate a folder having the same folder name as that of the MAC address under a predetermined folder created on the HDD and creating a multifunction device administration information file in the created folder.

Having generated and stored the multifunction device administration information (S103), the scan agent computer 50 returns the information indicating that the IP address registration/acknowledgment request has been successfully processed to the source device (digital multifunction device 10/control unit 11) of the IP address registration/acknowledgment request (S106). The scan agent computer 50 completes the IP address registration/acknowledgment processing.

In case the multifunction device information corresponding to the received IP address registration/acknowledgment request is stored in the computer (S101; YES), the scan agent computer 50 determines whether the device IP address included in the administration information matches the device IP address included in the received IP address registration/acknowledgment request (S104). In case both IP addresses match each other (S104; YES), the scan agent computer 50 executes S106 and the subsequent steps. In case the both IP addresses do not match each other (S104; NO), the scan agent computer 50 changes the device IP address in the multifunction device administration information having the same MAC address as that but a different device IP address from that in the received IP address registration/acknowledgment request to the device IP address included in the IP address registration/acknowledgment request (S105), then executes S106 and the subsequent steps.

Referring to FIG. 13 again, information stored in the scan agent computer 50 will be further described.

The user administration information stored for each used in the scan agent computer 50 includes a user name, a mail address, a user ID and a password.

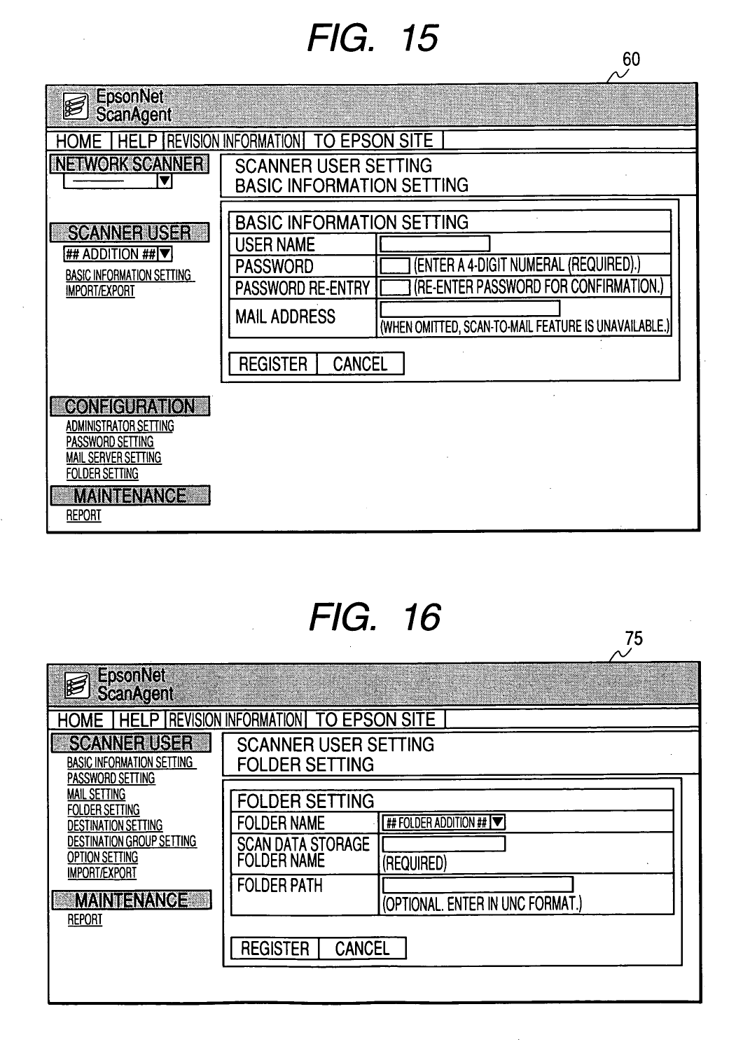

Storage (registration) of the user administration information into the scan agent computer 50 is made though an access to the scan agent computer 50 to cause a computer (web browser) to display a scan user setting page 60 shown in FIG. 15. The user ID in the user administration information is automatically generated as the identification information of each user (user administration information) by the scan agent computer 50 when the user administration information is registered by using the scan user setting page 60. The scan user setting page 60 cannot be displayed without login work which requires an administrator's name and a password (set in installation of the scan agent program 40 or modified afterwards) That is, the user administration information is set by the administrator.

The destination specification information for mail stored foe each user in the scan agent computer 50 includes a destination specification information name (name in the figure), a destination specification information ID (information ID in the figure) and a mail address. The destination specification information for group includes a destination specification information name, a destination specification information ID and a plurality of mail addresses. The destination specification information for storage includes a destination specification information name, a destination specification information ID and a folder path (information indicating a folder set to a computer on a network).

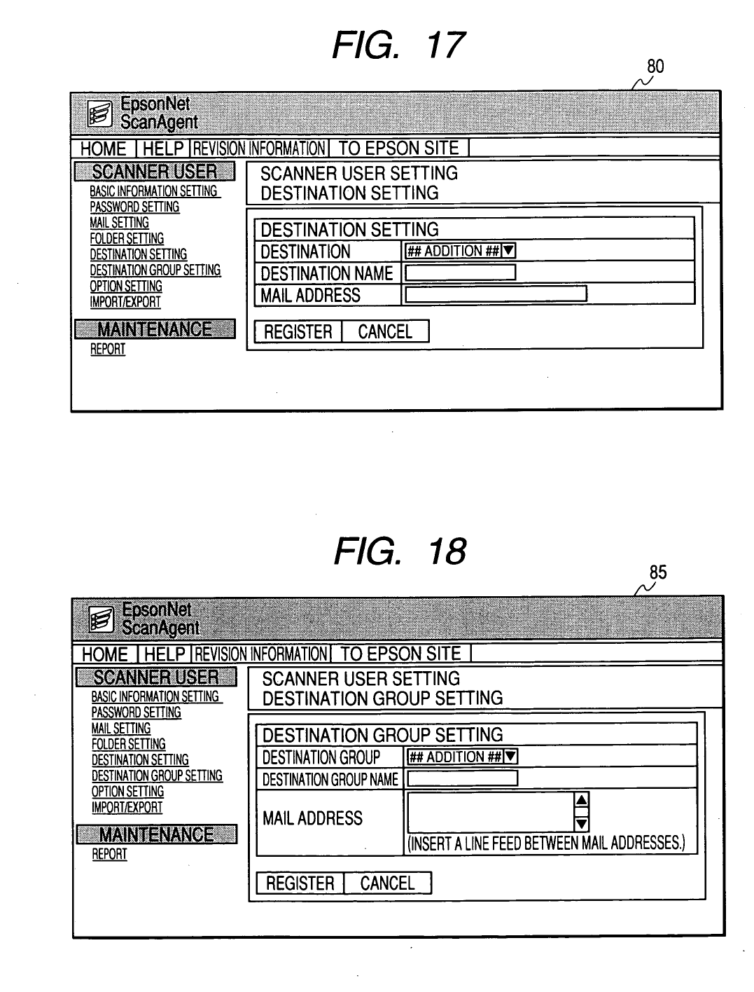

Storage (registration) of the destination specification information for folder into the scan agent computer 50 is made though an access to the scan agent computer 50 to cause a computer (web browser) to display a folder setting page 75 shown in FIG. 16. Storage (registration) of the destination specification information for mail into the scan agent computer 50 is made though an access to the scan agent computer 50 to cause a computer (web browser) to display a destination setting page 80 shown in FIG. 17. Storage (registration) of the destination specification information for group into the scan agent computer 50 is made though an access to the scan agent computer 50 to cause a computer (web browser) to display a destination group setting page 80 shown in FIG. 18.

Same as the user ID, the destination specification information ID in the destination specification information is automatically generated by the scan agent computer 50 when the destination specification information is registered by using each setting page. Each setting page is a web page which can be displayed after login work involving input of a user name and a password (user name only is a password is not set). When the “Registration” button on each setting page is pressed, the destination specification information (destination specification information for storage/mail/group) including various information input to a setting page and an automatically generated destination specification information ID is stored into the scan agent computer 50 as the destination specification information concerning the user who has logged into the system.

The digital multifunction device 10 (control unit 11) of the information processing system displays the user name selection screen 105 by using the user administration information group stored in the scan agent computer 50, displays the scan basic screen 110 or various item value selection screens 120 by using the selectable item information group, and displays the scan destination selection screen by using the destination specification information group.

In particular, as shown in FIG. 19, in case the mode selection button 101 is pressed, the control unit 11 transmits a user name request to the scan agent computer 50 (device having an agent IP address stored in the EEPROM 24) (S201). The information processing system is a system where various information is communicated between the control unit 11 and the scan agent computer 50 by way of a request body and a response body conforming to HTTP.

Receiving the user name list request, the scan agent computer 50 creates a user name list from the user administration information group (refer to FIG. 13) stored in the computer and returns the list to the digital multifunction device 10 (S301). The user name list refers to information including the number of registered users indicating the total count of user administration information items stored in the scan agent computer 50 as well as information including presence/absence of a user name, a user ID and a password (information indicating whether the user has set a password) on the basis of each user (user administration information item), which will be referred to as user name information.

Receiving the user name list, the control unit 11 displays a user name selection screen 105 shown in FIG. 6 on the touch screen 31 based on various information included in the user name list (S202).

To be more precise, the control unit 11 displays the user name selection screen 105 comprising six (or less than six) user name buttons 106 in which is shown the user name of each user name information item included in the user name list, a button 107b and a button 107n used to change a displayed page, and an area 108 in which is shown the current page number/total number of pages.

In case a user name button 106 on the user name selection screen 105 is pressed, the control unit 11 transmits to the scan agent computer 50 a login request including the user ID corresponding to the pressed user name button 106 (user ID in the same user name information as that shown in the user name button 106) (FIG. 19; S203).

While not shown in FIG. 19, in case the user name button 106 pressed pertains to a user who has set a password (in case the password presence/absence information in the same user name information as the user name displayed in the pressed used name button 106), the control unit 11 displays a password input screen on the touch screen 31 so as to let the user enter the password. The control unit 11 transmits to the scan agent computer 50 a login request including the password and the user name entered by the user.

Receiving the login request, the scan agent computer 50 checks that the information included in the login request (a user name, or a user name and a password) is correct and starts processing (session administration in the figure) of handling the request (HTTP request) from the control unit 11 which has transmitted the login request as a request from the user identified by the user name included in the login request (hereinafter referred to as the current user) (S302). The scan agent computer 50 returns the information (OK in the figure) that the login request is accepted to the digital multifunction device 10.

Receiving this information, the control unit 11 transmits to the scan agent computer 50 a selectable item information request used to return all the selectable information items (S204). Receiving this request, the scan agent computer 50 returns all the selectable information items to the control unit 11 (S303). The control unit 11, receiving the selectable information item group from the scan agent computer 50, stores the selectable information item group onto the RAM 23 (S205).

The control unit 11 displays the scan basic screen 110 mentioned earlier (FIG. 7) on the touch screen 31 by using part of the selectable information item group (S206) in the RAM 23.

That is, the control unit 11 displays the scan basic screen 110 in which the item value name corresponding to the default value concerning each processing condition item in the selectable information item group (item value name in the item value information whose item value ID is the same as the default value) is displayed in the set value presentation area 112, “file format” button 116, and single/double side selection button 117 and which has the density setting item 118 corresponding to the selectable information item concerning scan density.

In case the selectable information item group is stored in the RAM when information indicating acceptance of a login request is received, the control unit 11 displays the scan basic screen 110 without performing processing of S204 and S205 (performs the processing of S206).

The control unit 11 which has displayed the scan basic screen 110 waits for operation on the scan basic screen 110.

In case the scan destination selection/display button 119 is pressed, the control unit 11 transmits a scan destination list request to the scan agent computer 50 (S401).

Receiving the scan destination list request, the scan agent computer 50 creates a scan destination list and returns it to the control unit 11 (S501). The scan destination list includes the number of destination specification information items indicating the number of the number of destination specification information items stored in the computer in association with the current user and type information indicating whether the destination specification information item name, destination specification information ID and its destination specification information are destination specification information for storage, destination specification information for mail or destination specification information for group, concerning each destination specification information item associated with the current user. For each destination specification information item, the information group included in the scan destination list (destination specification information name, destination specification information ID and type information) will be hereinafter referred to as destination information.

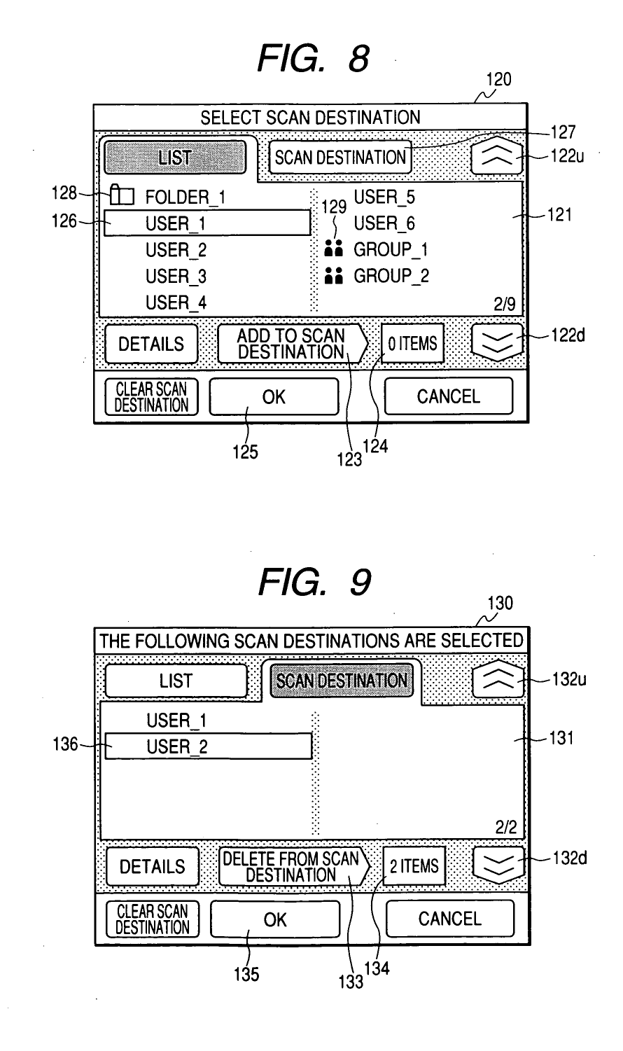

Receiving the scan destination list, the control unit 11 displays the scan destination selection screen 120 (FIG. 8) mentioned earlier on the touch screen 31 by using the scan destination list (S402).

The control unit 11 displays the scan destination selection screen 120 which shows each destination specification information name included in the scan destination list (such as “FOLDER1” and “USER_{—}1”) alone or together with the graphics 128 and the graphics 129 on the list area 121.

Having displayed the scan destination screen 120, the control unit 11 starts scan destination selection screen update processing (S403) which is the processing operating the scan destination selection screen 120 (and the scan destination check/deletion screen 130) where the user can select the destination specification information in the procedure described earlier.

The control unit 11 terminates the scan destination selection screen update processing when the “OK” button 125 on the scan destination selection screen 120 is pressed or the “OK” button 135 on the scan destination check/deletion screen 130 is pressed. Having terminated the scan destination selection screen update processing, displays the scan basic screen 110 where the information indicating the destination specification information selected by the user (information including several destination specification information names) is shown in the scan destination selection/display button 119 (S404).

In case a button which needs to display the item value selection screen on the scan basic screen 110, the control unit 11 refers to the corresponding selectable information item stored in the RAM 23 to determines the contents of the target item value selection screen and displays the screen.

As mentioned earlier, an item value selection screen displayed by the control unit 11 allows page switching (FIGS. 10 and 11) and another item value selection screen does not allow page switching (FIG. 12). The processing executed by the control unit 11 in displaying the former-type item value selection screen is processing of “displaying a screen where the item value selection button corresponding to the Nth (N=l to number of information items) in the selectable item information (the item value selection button in which is shown the item value name in the item value information and whose push is recognized as selection of an item value ID in the item value information) is shown in the mth button display position on the nth page, where n is the quotient (integer) obtained by dividing N by an integer K specified for the item value selection screen to be displayed and m is the remainder obtained when N is divided by K.”

The document size setting screen 140 (FIG. 10) is a screen where K is set to 8 displayed by this processing. The file format setting screen 140 (FIG. 11) is a screen where K is set to 4 displayed by this processing. On the file format setting screen 140, the first, second, third and fourth buttons appear in the upper left corner, upper right corner, bottom left corner and bottom right corner, respectively. The file format setting screen 140 in FIG. 11 appears when the selection item information concerning file format shown is as shown in FIG. 13.

The processing executed by the control unit 11 in displaying the latter-type item value selection screen is processing of “displaying a screen where the item value selection button corresponding to the Nth (N=1 to number of information items) in the selectable item information is shown in the Nth button display position among the M button display positions (a screen capable of displaying a maximum of M buttons).”

The document type setting screen (FIG. 12) is a screen displayed by this processing (M=3).

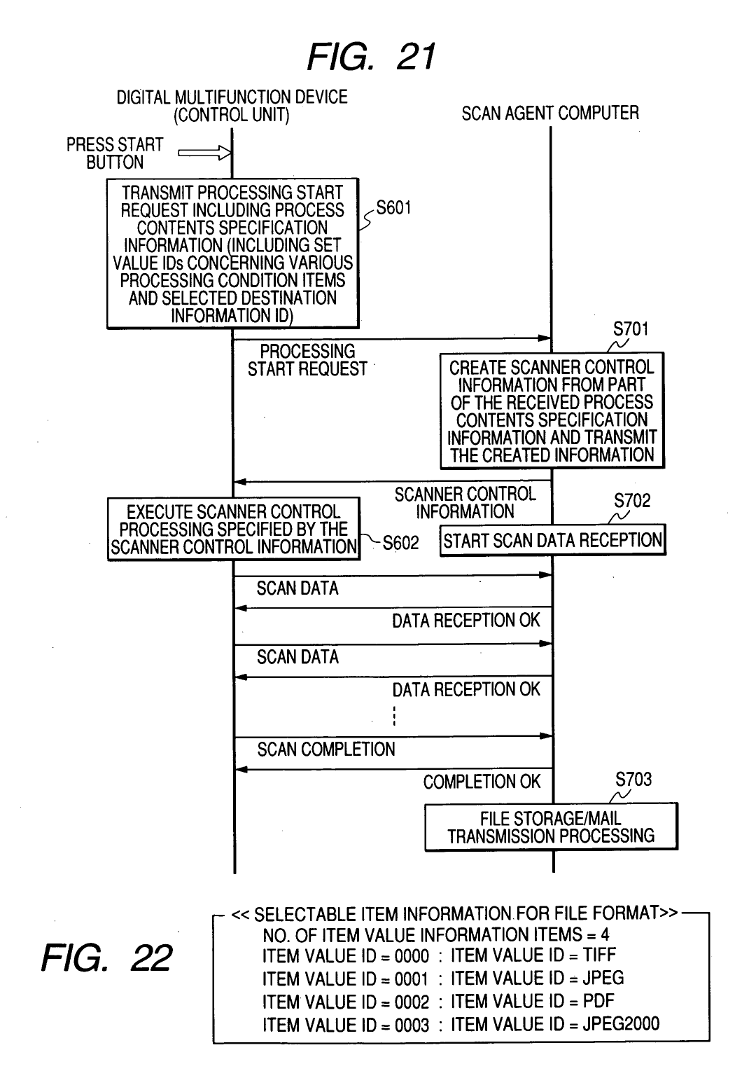

In case the start button 32s is pressed with the destination set, the control unit 11 transmits, as shown in FIG. 21, a processing start request including process contents specification information (corresponding to the user setting item value information of the invention) including a set value ID concerning various processing condition items and a selected destination specification information ID to the scan agent computer 50 (S601).

Receiving the processing start request, the scan agent computer 50 creates scanner control information (corresponding to the process contents specification information) based on part of the process contents specification information included (set value ID of each processing condition item related to control of the scanner 12) and returns the scanner control information to the control unit 11 (S701). The scanner control information refers to information used to notify the control unit 11 of the control details to be executed over the scanner 12, actually a command group for controlling the scanner.

Receiving the scanner control information, the control unit 11 performs control specified by the scanner control information over the scanner 12 (S602). In short, the control unit 11 causes the scanner 12 to perform operation as instructed by the scan agent computer 50.

The control unit 11 is starts to transfer the scan data transmitted from the scanner 12 to the scan agent computer 50.

The scan agent computer 50 which has returned the scanner control information to the control unit 11 starts the processing of receiving the scan data from the control unit 11 and storing the data into the HDD (S702).

Receiving the information indicating that transmission of all scan data is complete (scan completion in the figure) from the control unit 11, the scan agent computer 50 performs file storage/mail transmission processing (S702) in order to complete scan data transmission of the contents specified in the process contents specification information received in S701 That is, in S702, the scan agent computer 50 performs various types of processing such as the processing of generating a file of a file format specified by the received process contents specification information (a set value ID concerning the file format and a set value ID concerning the color type included therein), the processing of identifying the actual e-mail address and folder path of the destination of scan data from the received process contents specification information by referencing the destination specification information stored in the HDD, the processing of transmitting an e-mail to which the generated file is attached while assuming each identified e-mail address as a destination mail address, and the processing of storing the generated file into a shared folder identified by each folder path.

Finally, the procedure concerning improvement of the information processing system described above will be explained.

Assume a case where the information processing system is adapted to support the file format “JPEG2000”.

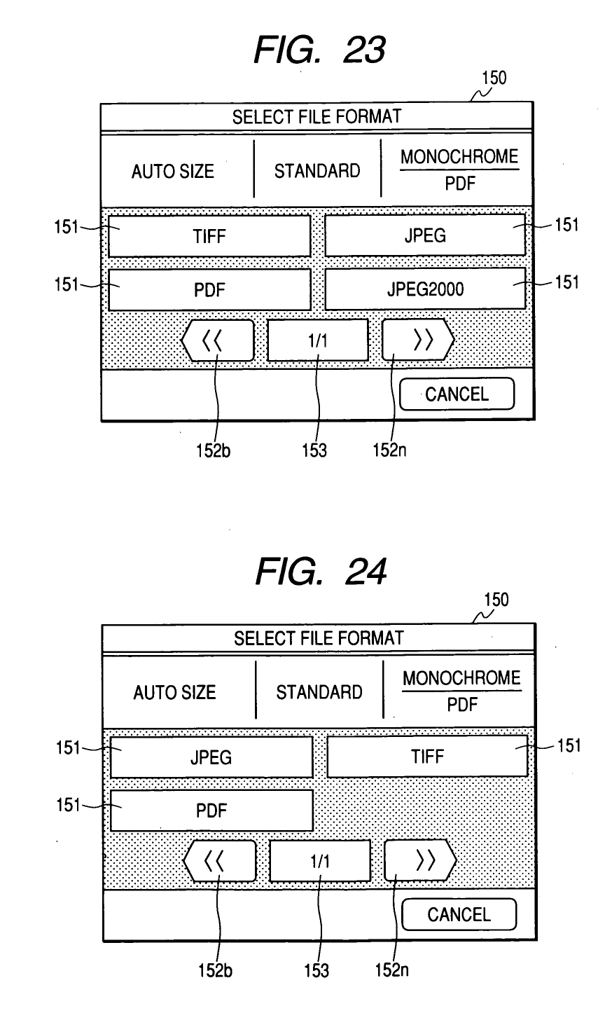

In this case, selection of “JPEG2000” must be made possible by way of operation of each digital multifunction device 10. The information processing system is a system where the item value selection screen specified by the selection item information in the scan agent computer 50 is displayed on the touch screen 31 of each digital multifunction device 10. In this practice, the selectable item information for file format in the scan agent computer 50 should be modified for example as shown in FIG. 22 so as to allow each digital multifunction device 10 to select “JPEG2000” as a file format. The file format setting screen 150 displayed when the selectable item information for file format is as shown in FIG. 22 is shown in FIG. 23.

In this case, the scan agent program 40 must be provided with a feature to generate a “JPEG2000” file. As a result, in order to support the file format “JPEG2000” a new, it is sufficient to modify the scan agent program 40 and the selectable item information for file format, irrespective of the number of digital multifunction devices 10 included in the system.

Another case is improvement of the information processing system to support more paper sizes.

In this case, each digital multifunction device 10 performs more types of control over the scanner 12. In the information processing system, details of the control over the scanner 12 by the digital multifunction device 10 (control unit 11) are instructed from the scan agent computer 50. Thus, in the case where the information processing system is adapted to support more paper sizes also, it is sufficient to modify the scan agent program 40 and the selectable item information, irrespective of the number of digital multifunction devices 10 included in the system.

The procedure to modify the screen contents (button display order and characters in the buttons) displayed on each digital multifunction device (control unit 11) in this information processing system is complete only by modifying the corresponding selectable item information. For example, to tailor the file format setting screen 150 displayed on each digital multifunction device 10 as shown in FIG. 24, the selectable item information for file format in the scan agent computer 50 should be modified as shown in FIG. 25.

<Variation>

The information processing system according to the embodiment may be modified in a variety of fashions. For example, while the information processing system is a system which performs scan data transmission processing, the information processing system may be a system which performs other information processing than the scan data transmission processing. The information processing system may be adapted so as not to communicate an item value ID between the digital multifunction device 10 and the scan agent computer 50 (scan agent program 30). In this case, an item value name cannot be changed when the item value name is directly input to the scan agent program 40. Thus, it is desirable to convert an item value name to an item value ID on the scan agent computer 50.

What is claimed is:

1. An information processing system comprising one or more information processors and auxiliary information processors which cooperates to execute information processing, wherein each of the one or more information processors comprises:
a user-interface unit that displays plural types of screens to allow a user to specify an item value of each of plural types of processing condition items concerning the information processing and displays a screen that represents contents specified by screen contents specification information acquired from the auxiliary information processor for some of the screens;
a user setting item value information transmitter that transmits, to the auxiliary information processor, user setting item value information including the item value of each of the plural types of processing condition items set by the user through the user-interface unit; and
a processing execution unit that executes processing of contents specified by process contents specification information transmitted by the auxiliary information processor and transmits processing result information to the auxiliary information processor;
wherein the auxiliary information processor comprises:
a process contents specification information transmitter that generates, on receiving the user setting item value information, the process contents specification information corresponding to the user setting item value information and transmits the user setting item value information to the information processor;
an information processing completion unit that completes, on receiving the processing result information, the information processing by performing secondary processing corresponding to the user setting item value information received from the process contents specification information transmitter concerning the processing result information; and
a screen contents specification information storage that stores the screen contents specification information on each of the some of the screens to be acquired by the user-interface unit of the information processor.

2. The information processing system according to claim 1, wherein the screen contents specification information stored into the screen contents specification information storage of the auxiliary information processor include information including a plurality of item values and an item value name associated with each item value, and
wherein the user-interface unit displays a screen where the item value name included in the screen contents specification information is shown.

3. The information processing system according to claim 1, wherein the auxiliary information processor is a computer storing an auxiliary information processing program for operating a computer as the process contents specification information transmitter, the information processing completion unit, and a screen contents specification information provision unit that provides the user with screen contents specification information.

4. The information processing system according to claim 1, wherein the processing execution unit generates image data representing an image on a document to be processed and transmits as the processing result information the generated image data to the auxiliary administration device.

5. The information processing system according to claim 4, wherein the user-interface unit allows the user to set an item value group including a storage location specification value which is an item value concerning a folder path, and
wherein the information processing completion unit performs, as the secondary processing, processing of storing a file of the image data transmitted as the processing result information into a folder specified by the storage location specification value included in the user setting item value information.

6. The information processing system according to claim 4, wherein the user-interface unit allows the user to set an item value group including a mail transmission specification value which is an item value concerning a mail address, and
wherein the information processing completion unit performs, as the secondary processing, the processing of transmitting an e-mail, to which the file of the image data transmitted as the processing result information is attached, to the mail address specified by the mail destination specification value included in the user setting item value information.
